(19) United States
(12) Patent Application Publication
(10) Pub. No.: US 2026/0346265 A1
(43) Pub. Date: Nov. 5, 2026

(54) DRY-GRANULATION OF PARTICULATE CARBON MATERIAL AND AGGLOMERATES PRODUCED THEREBY

(71) Applicant: Suncoal Industries GmbH, Ludwigsfelde (DE)

(72) Inventors: Jacob Podschun, Ludwigsfelde (DE); Alexander Stücker, Ludwigsfelde (DE); Ulf Lüder, Teltow (DE); Gerd Schmaucks, Ludwigsfelde (DE); Tobias Wittmann, Ludwigsfelde (DE); Florian Diehl, Neuss (DE); Moritz Leschinsky, Leipzig (DE); Christian Hübsch, Bad Wiessee (DE); Mauno Miettinen, Lappeenranta (FI)

(73) Assignee: Suncoal Industries GmbH, Ludwigsfelde (DE)

(21) Appl. No.: 19/146,813

(22) PCT Filed: Feb. 1, 2023
(86) PCT No.: PCT/EP2023/052468

§ 371 Date: Jul. 9, 2025

(51) Int. Cl. B02C 23/08; C01B 32/05; C08K 3/04

(52) U.S. Cl. CPC B02C 23/08; C01B 32/05; C08K 3/04; C01P 2004/60; C01P 2006/14

(57) ABSTRACT

Provided is a method for producing an agglomerated particulate carbon material. The method comprises providing a particulate carbon starting material comprising hydrothermally treated lignin particles, the particulate carbon starting material having a particle size ≤500 μm; compacting the particulate carbon starting material by applying a compaction force to form a compacted particulate carbon material; crushing the compacted particulate carbon material to form a crushed compacted carbon material; subjecting the crushed compacted carbon material to at least one granulator to further reduce the size of the crushed compacted carbon material, and form a mixture of agglomerated particulate carbon material having a particle size >500 μm and ≤5000 μm, and a particulate carbon material having a particle size ≤500 μm; and removing particulate carbon material having a particle size ≤500 μm and >5000 μm, if present, from the agglomerated particulate carbon material having a particle size in the range of >500 μm and ≤5000 μm. Also provided is an agglomerated particulate carbon material, which is obtainable according to the method, its use in polymeric material, as well as the polymeric material comprising particulate carbon material formed from the agglomerated particulate carbon material.

### FIELD OF THE INVENTION

The present invention relates to a dry-granulation method for agglomerating particulate carbon material comprising hydrothermally treated lignin, the agglomerates produced thereby and the use of the agglomerates in polymeric materials, particularly in rubber materials. The invention further relates to the polymeric material, particularly rubber material such as tires, tire components and other rubber articles, such as technical rubber articles, also referred to as mechanical rubber goods, MRG containing particulate carbon material formed by the process of dispersing the agglomerated particulate carbon material in the polymeric material, particularly rubber material.

### BACKGROUND OF THE INVENTION

The use of lignin-derived products obtained by hydrothermal treatment (HTT) of carbonaceous starting materials as reinforcing fillers has already been described in the literature and in various patents and patent applications. Thereby, the filler is dispersed in a polymer matrix and the mixture is vulcanized using a crosslinker. This is usually done at high temperatures (above 100 °C). Thus, a low water content in the vulcanizable composition is essential to minimize the evaporation of water during the vulcanization process in order to exclude as far as possible the formation of gas inclusions and the formation of porosities in the compound especially when the vulcanization process is performed without pressure. Consequently, the lowest possible water content in the filler represents an important quality criterion for the ease of manufacturing.

At the same time, to achieve excellent material properties of the vulcanized rubber compound, the reinforcing filler material must be dispersed to a small cluster unit and distributed as homogeneously as possible in the rubber matrix of the vulcanizable rubber composition. This requires small filler particles with a particle size distribution that is as uniform and narrow as possible.

However, reinforcing fillers with low water content and small particle size require special safety precautions regarding material handling. For example, the formation of dust clouds must be avoided, since under suitable conditions these can lead to dust explosions. In addition, dry, powder-like filler materials with small particle sizes are more difficult to dose, transport and process than moist materials or materials consisting of much larger particles.

For reinforcing fillers, however, there are additional requirements beyond material handling. For example, it must be ensured that the particles disperse quickly and as completely as possible when mixed into the polymer matrix. Polymer compositions with poorly dispersed fillers are usually characterized by insufficient mechanical and dynamical properties.

Consequently, the challenge is to provide a process for the production of a granule, or agglomerate, which is characterized by a high bulk density and stability as well as low abrasion and fines content of the granule or agglomerate, but at the same time the individual pellet hardness of the resulting granules should not be too high as otherwise its incorporation and dispersion in the polymer is insufficient and thus the dispersion quality as well as the mechanical properties of the vulcanizate are negatively affected.

Various patents and patent applications, e.g., RU 2 197 389 C1, RU 2005 125 522 A, WO 2009 037 943 A1, and US 2010/0154296 A1 deal with the compaction of lignin by roller presses into more compact forms, such as briquettes, where the lignin serves merely as a binder for a variety of other components and the resulting compositions in briquette form are used to generate energy by burning them. Obviously, the disclosure of these documents does not provide any teaching suitable for providing dust-reduced, dispersible reinforcing carbon materials obtained by hydrothermal treatment of lignin suitable for elastomer applications.

Patent application WO 2020/183383 A1 describes a process to produce agglomerated lignin, such as agglomerated Kraft lignin, offering the following advantages: avoidance of dust explosions due to a reduced fines content; improved handling, transportability, and storability; minimal material losses due to the use of a closed process and recycling of rejects. The process disclosed therein is carried out without addition of additives to the lignin starting material and comprises the steps of compaction of the lignin starting material, milling of the compacted material, and sieving out particles below 100 μm, to produce agglomerated lignin with a controlled particle size, e.g., for use as an intermediate in chemical synthesis processes, such as in the production of binders. Unlike the present invention, WO 2020/183383 A1, just aims to agglomerate non-hydrothermally treated lignin, i.e., precursor materials of the particulate carbon material of the present invention, in order to provide dust reduced lignins.

Particulate carbon materials such as hydrothermally treated lignins are important components in a wide range of technical applications. Particulate carbon materials from renewable sources are of particular importance in the context of the ecological transformation of modern industrial societies and the replacement of environmentally harmful fossil raw material sources.

Lignin-based particulate carbon materials are used as additives, i.e., reinforcing fillers, and/or pigments in a variety of industrial applications. The supply of such materials is mostly in the form of powders or dusts with varying moisture content. In addition to the moisture content, the particle size distribution as well as the bulk density, also referred to as pour density or volumetric density, are important parameters both for the processability of the material along the process chain and for the material properties of the resulting product after incorporation of the particulate carbon material into the target matrix material.

In this context, there is a trade-off regarding the material properties of the particulate carbon material: on the one hand, smaller particles lead to better physical characteristics in the product due to their better reinforcement when dispersed properly, but on the other hand they result in unfavorable properties during handling along the process chain like transportation, mechanical or pneumatical conveying and storage in silos. Excessive dust formation or even the formation of explosive dust-air mixtures is a high risk. Therefore, the provision of a particulate carbon material with controlled compacted and granulated form would offer a very significant improvement both in terms of storage and processing of such materials as well as in terms of the material properties of the final products after incorporation of the particulate carbon material and subsequent further processing of the resulting material mixture.

Lignin from hardwood, softwood, and annual plants, and thereof produced so-called Kraft lignins can be used as raw material to produce hydrothermally treated lignins suitable as particulate carbon materials that are utilized in technical applications, for example, as functional fillers in elastomers as described in WO 2017/085278. Such carbon material is typically also characterized in having a high specific surface area. However, such material is yet available only in powder form. Powder, composed of very small particles with a high specific surface area to volume ratio supports rapid combustion because the collective or combined surface area of all particles is very large compared to a material with larger particles. Dust explosions, the rapid combustion of fine particles suspended in air, can occur when powdered combustible material is present in sufficient concentration in the atmosphere or other oxidizing gaseous medium. Particulate combustible material with a high carbon content is particularly susceptible to dust explosions. Therefore, fine dust poses a much greater risk of explosion than coarse particles, such as granules or agglomerates, due to the larger total surface area of all particles.

It is one aim of the present invention to utilize such powdery carbon material in a particulate form having a reduced dust explosion risk, showing excellent handling, and processing, but also even providing improvements in reinforcement characteristics, if used a reinforcing filler in rubber applications.

To obtain a reduced dust explosion risk of powdery products it is a commonly known technique to produce so-called granules or pellets, i.e., agglomerated interlocked aggregates of such powders, manufactured to facilitate handling and processing.

The formation of granules from a powder, producing an agglomerated material, is called granulation and involves either agglomeration of fine particles into larger granules or shredding or grinding solid material into finer granules or pellets, whereby the size of the granules typically varies in a range between 200 μm and 4000 μm.

To produce granular or agglomerated material two types of technologies are used: wet granulation and dry granulation.

The wet granulation processes involve the addition of a granulation liquid optionally with an additive (binder) to support the binding process, usually water or low-boiling alcohols, onto a powder and subsequent agitation of the resulting mixture, e.g., by using an impeller, screws, or air, resulting in the aggregation of the primary powder particles to produce under the influence of the binder wet agglomerates or granules. Then, final drying of the wet material results in the granular or agglomerated material.

In the dry granulation processes the granules or pellets, are formed without addition of a liquid but through compacting and densifying primary powder particles, aggregates and/or smaller agglomerates under pressure, e.g., using a swaying granulator or a roll compactor.

Granulated, or agglomerated, material offers several advantages over powdered material. Granular material typically shows improved flow properties, as the particle size is larger and more isodiametric compared to powder.

Particularly material from renewable sources, such as lignin-based raw material of biological origin, primary powder particles and powdered aggregates show strong cohesion and poor flow properties due to their small particle size and irregular shape and surface characteristics.

Granulation also prevents segregation of the components of the powder mixture, which is caused by differences in size or density of the mixture components and results in smaller and/or denser particles concentrating in the lower area of a container, while the larger and/or less dense particles accumulate at the top.

This disadvantage also occurs particularly with renewable materials of biological origin. A particularly suitable granulation, or agglomeration, process is characterized by the fact that all the constituents of a mixture are evenly distributed in each individual granule and there is no segregation of the granules.

Moreover, granulation is a common method of increasing the size of grains of bulk materials and allows to create relatively stable structures, among others to facilitate material transport and to reduce dust generation during transportation, mechanical or pneumatical conveying into a storage device, during storage and further handling and processing of the dry granulated, or agglomerated, material in the production plant.

The afore-mentioned advantages of granulated, agglomerated, material become particularly important when the material must be incorporated into a matrix material, as is the case, e.g., in the provision of vulcanizable rubber compounds, and the material to be incorporated as a filler is of biological origin, as is the case, e.g., with lignin-based material from renewable sources. In this special case, it is of utmost importance for the property and performance profile of the resulting filler-reinforced rubber compounds that the filler is added to the matrix material with the most ideal flow property, which is essential for the weighing process of the filler before charging to the mixer. Furthermore, the granulated, or agglomerated material should possess a higher pour density, which is important to fill the mixing chamber of the internal mixer in a proper way and to avoid that dust is removed by the exhaustion system.

It has been therefore an objective underlying the present invention to provide a process that results in a dust-reduced, dried, and highly dispersible particulate carbon material with high internal and external specific surface area in the form of granules or agglomerates. A further objective of the present invention was to provide a filler material obtainable by said process which is suitable directly as such for incorporation into, preferably vulcanizable, rubber compositions, in particular to provide tire components such as tire treads and tire components for the tire substructure and/or to provide components for technical rubber goods, i.e., to provide a filler material with improved in-rubber performance compared with the non-agglomerated hydrothermally treated lignin-based particulate carbon material fillers of the prior art resulting in improved mechanical properties such as moduli, tensile strength and elongation at break, dynamic mechanical properties like dynamic stiffness, hysteresis and tear properties, increased media resistance and hydrolysis resistance as well as increased hardness of the corresponding vulcanizates. Furthermore, it has been an objective of the present invention to provide corresponding rubber compositions as such containing said particulate carbon material as filler.

### SUMMARY

The above objectives have been achieved by the subject matter of the claims of the present applications as well as by the preferred embodiments thereof disclosed in this specification herein after.

A first subject matter of the present invention provides a method for producing an agglomerated particulate carbon material, wherein said method comprises
a. providing a particulate carbon starting material comprising or consisting of hydrothermally treated lignin particles, the particulate carbon starting material having a particle size ≤500 μm;
b. compacting the particulate carbon starting material by applying a compaction force, thereby forming a compacted particulate carbon material;
c. crushing the thus obtained compacted particulate carbon material, thus forming a crushed compacted carbon material;
d. subjecting the crushed compacted carbon material to at least one granulator, thus further reducing the size of the crushed compacted carbon material, and forming a mixture of agglomerated particulate carbon material having a particle size >500 μm and ≤5000 μm, and a particulate carbon material, having a particle size ≤500 μm.
e. removing particulate carbon material having a particle size ≤500 μm and >5000 μm, if present, from the agglomerated particulate carbon material having a particle size in the range of >500 μm and ≤5000 μm.

This method and its preferred embodiments as described herein below is also referred to as “dry granulation method of the invention.”

A second subject matter of the present invention is an agglomerated particulate carbon material having a particle size in the range from >500 μm and ≤5000 μm and being obtainable by the method according to the invention.

This agglomerated particulate carbon material in form of pellets and its preferred embodiments as described herein below is also referred to as “pellets according to the invention,” or “agglomerated particulate carbon material of the invention,” or “target material of the present invention.”

A third subject matter of the present invention is the use of the agglomerated particulate carbon material of the invention for incorporation into polymeric material.

This use and its preferred embodiments as described herein below is also referred to as “use of the invention.”

A fourth subject matter of the invention is a polymeric material comprising particulate carbon material formed from the agglomerated particulate carbon material of the invention.

This polymeric material and its preferred embodiments as described herein below is also referred to as “polymeric material of the invention.”

A fifth subject matter of the invention is a rubber article comprising a polymeric material of the invention, the polymeric material being a vulcanized rubber material.

### DETAILED DESCRIPTION OF THE INVENTION

In the following the invention will be further described in more detail, particularly referring to preferred measures to achieve the aims of the present invention and to define general terms which are used throughout the description.

Since the present invention provides inter alia a rubber material comprising particulate carbon material formed from the agglomerated particulate carbon material of the invention, terms used herein are used, if not specified otherwise, in accordance or in analogy with the rubber vocabulary as defined in DIN ISO 1382:2016-07.

In the above-mentioned standard, the term “carbon black” is defined as a compounding ingredient consisting essentially of more than 95% elemental carbon in the form of near-spherical “particles” with major diameters less than 1 μm, generally coalesced into aggregates, the carbon black being produced by incomplete burning or thermal de-composition of hydrocarbons.

While in the present invention “carbon black” is not to be confused with the “particulate carbon starting material comprising or consisting of hydrothermally treated lignin particles” as used in the method of the present invention, many terms, particularly with respect to the aggregates, agglomerates and pellets used for “carbon black” are applied in analogy for the “particulate carbon starting material” as used in the method of the present invention.

The term “particle,” as used for carbon black, refers to the smallest discernible spherical or nearly spherical unit which can exist separately. While particles of the particulate carbon starting material of the present invention are not necessarily spherical or nearly spherical, they are otherwise in accordance with this definition.

“Groups of particles” are generally coalesced into “aggregates,” which are defined as a rigid group of coalesced particles which is the smallest entity that can be dispersed by normal rubber processing.

“Agglomerates” are defined as a group of interlocked aggregates that are easily separated by normal rubber processing, and “pellets” are agglomerates manufactured to facilitate handling and processing. Thus, “pellets” are also “agglomerates” and it is not distinguished between both terms as used herein. In literature the terms “pellets” and “agglomerates” are often interchangeably used with the term “granules” and therefore all three terms as used herein are used interchangeably.

The agglomerated carbon material particles being produced by the present invention have an agglomerate particle size, i.e., pellet particle size of >500 μm and ≤5000 μm. This is achieved by removing smaller sized and bigger sized particulate carbon material.

Since all smaller entities, such as primary particles, aggregates, and smaller agglomerates (all smaller than 500 μm) are not of particular interest for further use in the application fields of the agglomerated particulate carbon material of the invention, it is not necessary to further distinguish between the morphology of the material which is removed from the target material of the present invention.

Of course, removing particulate carbon material having a particle size ≤500 μm can also be accomplished by using a sieve with a mesh size of, e.g., 700 μm, because using such screen will also remove particles having a particle size ≤500 μm at the same time. The same applies vice versa to the upper limit of 5000 μm. Thus, removing particles, e.g., larger than about 4000 μm, will at the same time remove particles having a size of more than 5000 μm.

Consequently, removing particulate carbon material having a particle size ≤500 μm and >5000 μm means that at least such material should be removed, but not necessarily that all other particle sizes must remain in the range from >500 μm to ≤5000 μm.

### Method for Producing an Agglomerated Particulate Carbon Material

### Step a.

### Particulate Carbon Starting Material

In the method of the present invention a particulate carbon starting material is provided which comprises or consists of hydrothermally treated lignin particles having a particle size below 500 μm, preferably below 300 μm, more preferred below 100 μm, even more preferred below 50 μm and most preferred below 20 μm. Thus, particularly powders having very small particle sizes can be employed in the method according to the invention. A physical limitation of the lower size limit is just the smallest discernible unit which can exist separately.

The term “consisting of” means that the particulate carbon starting material is a particulate carbon material originating from a hydrothermal treatment of lignin including any subsequent drying and/or milling steps, but without adding any further separate ingredients. Such material may contain some impurities originating from the hydrothermal treatment and some residual moisture. Preferably the water content of the particulate carbon starting material should not exceed 5 wt.-%, more preferred 3 wt.-% and most preferred 1 wt.-% based on the total weight of the particulate carbon starting material, i.e., the dry matter is preferably from 95 to 100 wt.-%, more preferred 97 to 100 wt.-% and most preferred from 99 to 100 wt.-%. However, the term “consisting of” in view of the particulate carbon starting material includes such hydrothermally treated lignin particles, which have been crosslinked and/or surface-modified, i.e., crosslinked and/or surface-modified hydrothermally treated lignin particles.

The term “comprising,” in the above context, means that besides the hydrothermally treated lignin particles which are optionally crosslinked and/or surface modified, one or more further ingredients can be present in the particulate carbon starting material employed in step a. of the method according to the invention. Such further ingredients, are preferably being selected from waxes and plasticizers, such as oils or binders.

However, any of such further ingredients should only be employed in quantities which do not conflict with the objectives of the subsequent compacting, crushing and granulating steps. Preferably, the amount of hydrothermally treated lignin particles in the particulate carbon starting material is at least 85 wt.-%, more preferred at least 90 wt.-% and most preferred at least 95 wt.-%, and even more preferred 100 w.-% based on the total weight of the particulate carbon starting material. In a particularly preferred embodiment, no further waxes, oils and/or binders are contained in the particulate carbon starting material. The term “comprising” also includes the possible presence of limited quantities of particles larger than 500 μm. However, the presence of such particles is not preferred, and if such particles are part of the starting material, the amount of such particles should preferably not exceed 10 wt.-%, more preferred 5 wt.-% and most preferred 2 wt.-% of the total weight of the starting material. Most preferred, such particles are not contained in the particulate carbon starting material of the present invention. The presence of such larger aggregated and/or agglomerated particles can, e.g., be avoided by sieving the particulate carbon starting material prior to providing such material in step a. of the method according to the invention.

Of course, it is also possible to employ those primary particles, aggregates and/or agglomerates having a particle size below 500 μm which have been removed from the target agglomerated particulate carbon material in step e. of the method according to the invention, and/or mixtures of such removed material with any of the afore-mentioned particulate carbon material which has not yet undergone the granulation method of the present invention and which has a particle size below 500 μm. Generally, it is preferred that the particulate carbon starting material consists of particles forming a homogenous material having a narrow particle size distribution. Therefore, it is also possible to mill the primary particles, aggregates and/or agglomerates having a particle size below 500 μm as removed in step e. before returning and/or combining such particles with a non-granulated fraction of particulate carbon starting material to provide a recycled particulate carbon starting material having a particle size distribution being more like the non-granulated fraction of particulate carbon starting material as provided in step a.

The hydrothermally treated lignin, which is used as particulate carbon starting material in the method of the present invention, can e.g., be obtained as disclosed in WO 2015/018944 A1 and WO 2017/085278 A1. The hydrothermally treated lignin is not to be confused with Kraft lignin which might be a starting material in the production of hydrothermally treated lignin. Thus, Kraft lignin is not encompassed by the term hydrothermally treated lignin.

The herein used hydrothermally treated lignin originates from phytomass, preferably dead phytomass. Dead phytomass includes, but is not limited to, dead or detached plants and parts of plants. These include, for example, broken and torn leaves, cereal stalks, side shoots, twigs and branches, fallen foliage, felled or pruned trees, and seeds and fruits and components derived therefrom, as well as sawdust, sawdust, and other products derived from wood processing.

For purpose of the invention, the lignin is isolated, extracted and/or dissolved from phytomass to produce the lignin-based hydrothermally treated particulate carbon material. Preferably, the hydrothermal treatment is carried out at temperatures from 100 °C to 300 °C, particularly preferably from 150 °C to 250 °C, in the presence of liquid water.

Since lignin is a renewable raw material, the hydrothermally treated lignin has a ¹⁴C content that is greater than 0.20 Bq/g carbon, more preferably greater than 0.23 Bq/g carbon, but more preferably less than 0.45 Bq/g carbon, even more preferably less than 0.40 Bq/g carbon, particularly preferably less than 0.35 Bq/g carbon. This is just one feature distinguishing industrial carbon blacks produced from fossil raw materials from the lignin-based particulate carbon starting material as used in the present invention.

Moreover, the hydrothermally treated lignin contained in the particulate carbon starting material preferably has a carbon content in the range from 55 wt.-% to 90 wt.-%, more preferably from 58 wt.-% to 85 wt.-%, most preferably from 60 wt.-% to 82 wt.-%, most preferably from 60 wt.-% to 80 wt.-% as determined by elemental analysis according to DIN 51732 (July 2014). This carbon content clearly distinguishes hydrothermally treated lignin from both carbon blacks such as industrial carbon blacks produced from fossil raw materials and carbon blacks produced from renewable raw materials, since carbon blacks have a corresponding carbon content of at least 95% by weight.

The hydrothermally treated lignin preferably has a statistical thickness surface area (STSA) in the range from 2 m²/g to 180 m²/g, from 5 m²/g to 180 m²/g, more preferably from 10 m²/g to 180 m²/g, even more preferably from 15 m²/g to 180 m²/g, most preferably from 20 m²/g to 150 m²/g, particularly preferably from 20 m²/g to 120 m²/g. The method for determining the STSA is provided below in the experimental part of the specification.

The hydrothermally treated lignin contained in the particulate carbon starting material used in the method according to the invention preferably has a BET surface area (total specific surface area according to Brunauer, Emmett and Teller), which advantageously, only deviates by a maximum of 20%, more preferably by a maximum of 15%, and most preferably by a maximum of 10% from the STSA surface. The method for determining the BET surface area is given below in the methods section.

Preferably, the hydrothermally treated lignin contained in the particulate carbon starting material used in the method according to the invention has an oxygen content in a range from 8 wt.-% to 35 wt.-%, more preferably from 10 wt.-% to 32 wt.-%, most preferably from 15 wt.-% to 30 wt.-%, most preferably from 20 wt.-% to 30 wt.-%, each determined by high-temperature pyrolysis, for example by means of the EuroEA3000 CHNS-O analyzer from EuroVector S.p.A. as the difference to C, H, N and S.

Preferably, the hydrothermally treated lignin has at least one functional group selected from phenolic OH groups, phenolate groups, aliphatic OH groups, carboxylic acid groups, carboxylate groups and mixtures thereof.

Preferably, the hydrothermally treated lignin has a pH in a range from 7 to 9, more preferably in a range from 7.2 to 8.8, most preferably in a range from 7.5 to 8.5.

The term “providing” the particulate carbon starting material as used in step a. of the method according to the invention encompasses any way of supplying, i.e., feeding the particulate carbon starting material to a compacting device.

In case of roller compaction, which is the preferred method of compacting the particulate carbon starting material, the starting material is typically provided by means of a so-called feed hopper equipped with a feed screw, preferably equipped with a vacuum unit to the compaction rollers.

The mechanics of how this is done is given by the orientation of the rollers which can be horizontally, vertically, or inclined. Horizontally or inclined rollers can be fed by gravity. However, since gravity is constant and the particulate carbon starting material has a rather poor flowing property this leads to a less preferred process control and a significant amount of uncompacted material may fall through the roller gap especially during start up and shut down but also during the regular operation of the compaction. This effect can be minimized using a feed screw, but in horizontally or inclined rollers, gravity will always be a constant that makes it hard to control the uncompacted material. Furthermore, leakages always fall into the same direction as the compacted particulate carbon material (herein also denoted as flake, ribbon, or sheet), which makes it difficult to separate the leakages from the produced flakes.

Thus, using the preferred roller compaction, it is further preferred that the rollers are vertically oriented. Providing the particulate carbon starting material, i.e., feeding of the material to the rollers can be controlled precisely by a feed screw which decreases the amount of losses during start up and shut down. However, uncompacted the particulate carbon starting material that escapes can be easily separated from the flake and can be collected and recycled.

The optimal way of bringing the powder between the rollers is of major importance for the flake quality. For feeding, it is important to have an even distribution of the material along the roller width to guarantee an even application of the compaction force to the powder along the roller width. Furthermore, because the particulate carbon starting material gets compacted, which essentially means that the air is pushed out of the product, it is necessary to provide a path for the air to escape from the product. Therefore, the particulate carbon starting material should not be pre-compacted in the feed screw, since this would decrease the permeability of the powder and block the way back through the feed screw for the air. When the feed screw is conveying the particulate carbon starting material without pre-compacting it, the air can go back through the screw and come out of the hopper or through a second chamber. Such second chamber can also be used for recycling and mixing of non-compacted particulate carbon starting material, or the smaller sized agglomerated particulate carbon material as separated in step e. of the method according to the invention back into the process.

It is also common to equip the hopper with a stirrer, knocker, or vibrator to destroy any undesirable solid bridges and non-filled holes in the hopper.

To obtain a more homogeneous product and to increase the throughput, the feed screw can also be equipped with a vacuum unit.

### Step b.

In step b. the particulate carbon starting material which is provided in step a. is compacted by applying a compaction force, thereby forming a compacted particulate carbon starting material.

Compaction of the particulate carbon starting material can in principle be accomplished by any known means of compaction. Typically, the compaction is based on an interparticle bond formation, which, according to R. W. Miller, “Roller Compaction Technology,” in Handbook of Pharmaceutical Granulation Technology, New York, USA, Marcel Dekker, 2010, pp. 163-182 can be characterized by the following steps in this order:
1. Particle rearrangement: occurs initially as powder movement begins filling void spaces. Air begins to move closer together, thereby increasing the powder blend's density. Particle shape and size are key factors in the rearrangement process. Spherical particles will move less than other-shaped particles because of their close initial packing.
2. Particle deformation: occurs as compressional forces are increased. This deformation increases the points of contact between particles where bonding occurs and is described as plastic deformation.
3. Particle fragmentation: is the next stage of bonding formation. It happens at higher compressional force levels. Here, particle fracturing creates multiple new surface sites, additional contact points, and potential bonding sites.
4. Particle bonding: occurs when plastic deformation and fragmentation happen. It is generally accepted that bonding happens at the molecular level and is due to van der Waals forces.

As stated above, it is preferred that compaction is accomplished by roller compaction. It is most preferred, that compacting the particulate carbon starting material by applying a compaction force, thereby forming a compacted particulate carbon material is accomplished by roller compaction making use of a roller compactor comprising compaction rollers, wherein the gap between the compaction rollers is in the range from 1 to 8 mm and the compaction force is effective in said gap.

In roller compaction the rollers compress the particulate carbon starting material to so-called flakes, also denotes as ribbons.

Such flakes or ribbons have a thickness which is determined by the gap between the rolls (“roller gap”) of the roller compactor. The compaction force (“roller force”) and the roller gap (also called separation), and to a lower extend the roller speed, determine flake properties such as density of the flakes. Generally, the relative density increases strongly with roller force and decreases slightly with the roller separation (roller gap). Typically, the impact of the roller gap increases when higher roller forces are applied. However, it can also be seen, that the throughput can be increased by increasing the roller gap, this correlation is linear in most cases and can be linked to the feed screw speed. But to compensate the effect of the higher roller gap the compaction force needs to be increased to compensate for the loss in relative density.

Even though the flake density rises when the compaction force is increased, this effect is limited. Generally, the flake density rises with the pressure (typically almost linear for low and medium pressure) and starts to level off for higher pressures. The latter also reflects in the bulk or pour density of the agglomerated particulate carbon material of the invention

Preferably, the desired pour density of the agglomerated particulate carbon material of the invention is in the range from 100 to 600 g/L, 150 to 500 g/L, more preferably in the range from 200 to 400 g/L and most preferably in the range from 250 to 350 g/L. Knowing about the relationship between compaction force and roller gap and their influence on the pour density, one of skill in the art can easily adjust the compaction force and/or roller gap to get products in the afore-mentioned ranges.

In the method of the present invention, it has been found that when using a roller compactor, the compaction force is preferably in the range from 0.02 to 1.50 kN/cm, more preferred in the range from 0.04 to 1.00 kN/cm and even more preferred in the range from 0.05 to 0.5 kN/cm, such as 0.05 to 0.20 kN/cm.

It has also been found that, if using a roller compactor, it is preferred that the roller gap is in the range from 1 to 8 mm, more preferred 1.5 to 7 mm, and even more preferred 2 to 6 mm, most preferred 2.5 to 5 mm.

Observing the afore-mentioned parameters of the compaction force and roller gap typically leads to the most desirable pour densities of the agglomerated particulate carbon material of the invention, but also to averaged individual pellet hardness values observed for the agglomerated particulate carbon material of the invention being preferably in the range from 10 to 100 cN, more preferably 12 to 70 cN and most preferably 15 to 40 cN.

Most preferably, compacting the particulate carbon starting material is accomplished by applying a compaction force in the range from 0.02 to 1.50 kN/cm to form a compacted particulate carbon material having a thickness in the range from 1 to 8 mm.

When using a roller compactor, the compacted particulate carbon material having a thickness is typically the same as the roller gap.

Thereby, the compaction force and thickness of compacted particulate carbon material can be varied to obtain the agglomerated particulate carbon material having a particle size in the range of >500 μm and ≤5000 μm; and having an averaged individual pellet hardness in the range from 10 to 100 cN and/or a pour density in the range from 100 to 600 g/L. Higher compaction force and/or lower thickness of the compacted particulate carbon material lead typically to a higher pellet hardness and higher pour density. Thus, depending on the application the desired re-dispersibility one of skill in the art can vary said parameters to obtain a desired pellet hardness and pour density of the target material.

As described above, pre-compaction in the feed screw is to be avoided. This can, e.g., be avoided by the design of the roller surface. Structured surfaces can create a situation in which the material is drawn into the gap between the rollers (roller gap) by the rollers themselves. When the material is fed towards the rollers, they enter the region that is called the slip area. In this area the friction between the rollers and the powder accelerates the powder until it reaches the same velocity as the roller. The area of zero velocity difference between powder and roller is the so-called nip-area. After the powder has entered the nip area the density of the powder increases rapidly. This area is where the powder is converted into the flake. To draw the particulate carbon starting material into the gap, it has been found advantageous to use roller having a structured surface such as a grooved, knurled, or squared surface or a combination of any of the afore-mentioned surfaces.

A situation occurring when using roller compactors, which are the preferred means of compaction is that side deal losses may occur. Side seal losses are uncompacted material, that falls off at the sides of the rollers. When the rollers are oriented vertically, they can be separated from the flakes via a separation chute by gravity. These losses can also be minimized by using the vacuum system on the feed screw or by using side sealing system on the rollers. There are two approaches for the side seals. The first option are static side seals, which are plates that are mounted at the side of the roller gap. This option typically leads to a situation, where more material is pushed to the center than to the sides of the rollers. This subsequently leads to more pressure being applied to the product at the center than at the sides of the rollers. As an alternative, circumferential side seals can be used. This means that rims are mounted to the lower roller and the upper roller is running in between these rims, this can however lead to an over-compression and material sticking in the edges of the circumferential side seals, which cannot happen when using static side seals. Unavoidable side seal losses can however be recycled by returning them to the particulate carbon starting material in step a.

### Step c.

After the compaction step b. crushing the thus obtained compacted particulate carbon material to form a crushed compacted carbon material is performed. This is the first size reduction step.

The flake, ribbon, or sheet, that was produced in the roller compaction now needs to be milled down into a defined granulate with a reproducible particle size.

In step c. such the flakes, ribbons, or sheets are rather coarsely cut into pieces (crushed) by using a crusher. This can, e.g., be accomplished by a crusher with rotating blades. This step serves to crush the flakes, ribbons or sheets into pieces which can easily be fed to the at least one subsequent granulation step, wherein the coarse particles are sized to obtain a narrow or narrower agglomerate size distribution.

### Step d.

In this step the crushed compacted carbon material is subjected to at least one granulator, thus further reducing the size of the crushed compacted carbon material, and forming a mixture of agglomerated particulate carbon material having a particle size >500 μm and ≤5000 μm.

The upper and lower particle size limits set above are to be understood in that the presence of smaller particles produced in this process is not excluded, but not desired. Typically, during granulation, it is unavoidable that to some extend particulate material is formed having a particle size smaller than desired. However, step e. aims to remove such smaller particulate carbon material as far as technically reasonable.

The preferably used granulator comprises a rotor with preferably inclined rotor bars and a preferably inclined screen mesh through which the crushed compacted carbon material is pushed by the rotor. By hitting the incoming crushed compacted carbon material (flakes), the material undergoes further pre-crushing, before it is supplied to the working zone of the granulator. In this zone the particle size is reduced by pushing the material through the respective screen.

The most important parameters for the granulation in the at least one granulation step are the mesh size of the respective screen, the mesh type, and the granulator speed. The mesh size defines the maximum particle size, such as the above mentioned 5000 μm, of the agglomerated particulate carbon material leaving the screen. Using standard round wire screens, an oversize free crushing can be achieved. The term “oversize free” means that almost all particles have a particle size below the mesh size of the screen. However, it is also possible, but typically less preferred to use square wire meshes or conidur screens.

Generally, the mesh size determines the upper limit of the particle size of the agglomerated particulate carbon material. Furthermore, the mesh size producing the final product (target product) is preferably smaller than the thickness of the crushed flakes, ribbons, or sheets, thus being smaller than the gap between the rollers, if roller compaction is selected in the compaction step.

Since it is an aim of the present invention to provide agglomerated particulate carbon materials possessing a low pellet hardness, but an increased pour density compared to the starting material while still possessing good handling characteristics, it is preferable that the granulator speed is not too high in order to avoid that the agglomerated particulate carbon material breaks to particle sizes below 500 μm.

Additionally, the gap between the rotor and the screen has an impact on the product quality. This position can be adjusted and should preferably be as close as possible without making metal to metal contact. A large gap can result in a reduction of the throughput due to blockages of the screen or the number of fines can increase as the material is not being pushed through the screen in one granulation cycle. To avoid a gap between the granulator and the screen, it can either be adjusted manually or automatically.

It is preferred that the crushed compacted particulate carbon material is subjected to either
i. one granulator comprising a screen, the screen having a mesh size >500 μm to ≤5000 μm and the crushed compacted material being pressed through the screen, or even more preferred to
ii. two or more granulators in a row, each granulator comprising a screen, the screen of the first granulator having the largest mesh size and the screen of the last granulator having a mesh size in the range from >500 μm to ≤5000 μm, and the crushed compacted material being pressed through the screen of the first granulator, and in any subsequent granulator the carbon material which was down-sized by the preceding granulator is pressed to the screen of the respective granulator.

In such systems comprising more than one granulator, the work that must be done by each granulator is reduced, which results in a higher capacity and a further reduction of the undesirable produced fines, due to a more defined energy input into the material in each step.

If more than one granulator is used, the screens of the granulators are selected in that the mesh size of the screen of each subsequent granulator is lower than the mesh size of the screen of the preceding granulator. Of course, the mesh size of the screen of the last or the only one granulator determines the maximum size of the agglomerated particulate carbon material which is the target material of the method according to the invention.

For example, if the thickness of the compacted particulate carbon material, i.e., the thickness of the flakes, ribbons, or sheets, or if roller compaction is performed, the gap is in the range of 1 to 8 mm, and if more than one granulator is used, the first granulator may preferably be equipped with a screen having a mesh size equal to the thickness of the compacted particulate carbon material or the roller gap, or even larger, thus producing a first batch of still rather large pellets, while the second and/or last granulator should likewise be equipped with a screen determining the largest desired particle size of the target material. If the first screen has a mesh size larger than the thickness of the compacted particulate material or the roller gap, the mesh size preferably exceeds the thickness of the compacted particulate material or the roller gap by not more than 100%, more preferred by not more than 80%, 60% or 50%.

Although the above granulation procedure of step d. aims to avoid destroying agglomerated particulate carbon material having the targeted particle size, it is unavoidable that due to the energy impact a part of the desired particles breaks to particles which are smaller than desired.

In the method according to the invention, it is not desired to obtain particulate carbon material, having a particle size ≤500 μm or particles possessing a size of <125 μm. According to DIN ISO 1382:2016-07 carbon black agglomerates, pellets or pellet fragments which pass through a sieve of aperture size 125 μm under specified conditions are regarded as fines. In analogy, in the present invention particulate carbon material passing through a sieve of aperture size 125 μm are regarded as fines. How to determine fines is disclosed in detail in the experimental part of the present invention.

Such particles are typically far lower than the lower desired limit of the particle size of the agglomerated particulate carbon material to be obtained in the present invention. Thus, such smaller particles which contribute to the risk of dust explosions and which further might be disadvantageous in view of handling and procession should be removed from the particulate carbon material having a particle size in the range of >500 μm and ≤5000 μm.

### Step e.

Consequently, in step e. the particulate carbon material having a particle size ≤500 μm and, if contained, >5000 μm is removed from the agglomerated particulate carbon material having a particle size in the desired range of >500 μm and ≤5000 μm.

This is preferably accomplished by using sieves having the respective mesh size to retain the desired target material and to thus removing particles having a size below the lower desired particle size limit. Any of the removed or separated particles may be re-introduced in step a. with or without milling to similar sizes as present in the particulate carbon starting material. As is known to one of skill in the art, removing particulate carbon material having a particle size ≤500 μm is effective, however, very small amounts of such material may loosely adhere to agglomerated particulate carbon material having a particle size >500 μm and thus small amounts of particulate carbon material having a particle size ≤500 μm may remain in the target material. Preferably the amount of particulate carbon material having a particle size ≤500 μm, which may remain in the target material is less than 10 wt.-%, more preferably, less than 7 wt.-%, even more preferred less than 5 wt.-% and most preferred less than 3 wt.-% or less than 2 wt.-% based on the total weight of the agglomerated particulate carbon material according to the invention.

The method of the present invention is preferably carried out as a continuous method. However, compaction and/or granulation can also be carried out batchwise, and even making use of compaction means differing from roller compactor. Nevertheless, the forces or pressure to be applied to compact the particulate carbon starting material to form flakes, ribbons, or sheets can also be applied in static compactors and the thickness of the compacted particulate carbon material can be predetermined by the amount of the particulate carbon starting material and its filling height before being compacted, e.g., between to plates applying the respective pressure.

The general use of the preferred roller compactors and granulators and the combination of both for granulation purposes are, e.g., described in WO 2001/036079 A1, WO 2003/076172 A1, WO 2016/142251 A1, and WO 2022/189061 A1; or in the Handbook of Pharmaceutical Granulation Technology, Editor: D. M. Parikh, 4th Edition, CRC Press, 2021, Chapter 8, “Roller Compaction Technology”.

Roller compactors which are suitable for carrying out the complete method according to the invention are, e.g., commercially available from Alexanderwerk AG, Remscheid, Germany under the tradenames WP 120 Pharma and particularly WP 200 Pharma.

### Preparation of Customized Pellet Particle Size Distributions

With the method of the present invention, it is possible to provide customized pellet particle size distributions by using—as the one or last granulator—a granulator with a screen having a mesh size determining the upper particle size limit of the desired pellet particle size distribution, since, as described in above step d, this step allows for an oversize-free production of agglomerated particulate carbon material.

The lower limit of the particle size of the desired particle size distribution can be set by the last step, i.e., step e. of removing particulate carbon material having a particle size ≤500 μm, which can be accomplished by a sieving step.

Thus, e.g., if it is desired to produce an agglomerated particulate carbon material having a particle size in the range of 1000 to 2000 μm, this can be accomplished by using as the only or last granulator a granulator equipped with a screen having a mesh size of 2000 μm in step d, and sieving the obtained material with a sieve having a mesh size of 1000 μm in step e.

Such material perfectly fulfills the requirements of the method according to the present invention, since in step d. a mixture of agglomerated particulate carbon material having a particle size >500 μm and ≤5000 μm, and a particulate carbon material, having a particle size ≤500 μm is formed.

The agglomerated particulate carbon material having a particle size >500 μm and ≤5000 μm is present, namely agglomerated particles having a size up to 2000 μm (which is ≤5000 μm) and all smaller particle sizes are also still present, even particles having a particle size ≤500 μm, because sieving has not yet been accomplished.

Furthermore, the requirements of step e. are fulfilled, i.e., removing particulate carbon material having a particle size ≤500 μm and >5000 μm, if present, from the agglomerated particulate carbon material having a particle size in the range of >500 μm and ≤5000 μm.

Since the method allows oversize-free production, agglomerated particles having a particle size >5000 μm are typically not even present and do thus not have to be removed. In the unlikely event that they are present, they can easily be removed by sieving with a sieve having a mesh size of 2000 μm, which removes not only the particles with a particle size >5000 μm, but also particles with a particle size between 2000 and 5000 μm, which is in compliance with the method according to the invention. To guarantee the lower limit cut-off of the desired pellet size range of 1000 μm, a sieve with a mesh size of 1000 μm can be used, thus removing particles having a particle size ≤500 μm, but in addition particles having a size between 500 and 1000 μm, which is also in compliance with the method according to the invention.

Consequently, by equipping the one or last granulator with screens having a definite mesh size, any upper limit of the agglomerated particulate carbon material size can be set and by using a respective sieve in step e. any lower limit of the desired agglomerated particulate carbon material size can be set. The only requirement is that particles with sizes lower than the desired lower limit are removed, including the fraction having a particle size ≤500 μm and that particles having a larger sized than the desired upper limit are either not produced or removed, including the fraction having a particle size >5000 μm.

### Agglomerated Particulate Carbon Material

The present invention further provides an agglomerated particulate carbon material having a particle size in the range from >500 μm and ≤5000 μm (i.e., “target material”). This material can be obtained by the method according to the invention.

The agglomerated particulate carbon material according to the present invention, obtained by said process, offers several advantages compared to the state of the art. Due to its largely dust-free nature and its low granulate abrasion the agglomerated particulate carbon material shows improved material and explosion characteristics.

“Dust explosion” is defined as the occurrence of flame propagation in a dust-air mixture after ignition, which is associated with an increase in pressure in a closed container. The maximum explosion pressure and the maximum pressure increase, or Kₛₜ value, provide information about the explosive strength of a dust and quantify the maximum effects to be expected from a dust explosion: the smaller the Kₛₜ value, the lower the explosive strength.

The examination of the burning behavior provides information as to whether and to what extent a fire initiated by external ignition can spread in deposited dust, which is present as a flat fill. The burning behavior is characterized by the combustibility index: the smaller the combustibility index, the worse a fire is propagated by a given material in dust form.

It was found that the agglomerated particulate carbon material according to the present invention has particularly favorable explosion parameters, such as a low Kₛₜ value and a low combustibility index.

Due to the removal of particles having a size ≤500 μm after granulation to obtain the target material, this material belongs into the dust explosion class 2 or lower, corresponding to a Kₛₜ value <300, thus improve explosion prevention during storage and processing of the material. The dust explosion class and Kₛₜ value can be determined as described in the experimental section of the specification.

Furthermore, the target material is characterized by a combustibility index at 100 °C of 4 or lower. The combustibility index can be determined as described in the experimental section of the specification.

Furthermore, the median pellet size of the target material is in the range from 500 μm to 5000 μm, preferably in the range from 600 μm to 4800 μm, more preferably in the range from 700 μm to 3500 μm and most preferably in the range from 750 to 2500 μm. The median pellet size can be determined as described in the experimental section of the specification.

For the processing of the agglomerated particulate carbon material of the invention as a functional filler, e.g., in rubber applications, it is of crucial importance to achieve, in terms of material properties, the appropriate balance between pellet hardness and re-dispersibility. While the hardness of the particles is important in order not to allow the abrasion of the particles to become too great during the pneumatic conveying usually used as part of the technical processing, because otherwise the apparatus components involved in the conveying can quickly become clogged, the hardness of the particles must not be too high, however, in order to ensure rapid and uniform re-dispersibility, e.g., in a rubber matrix prior to vulcanization.

On the target product, pellet hardness was determined as described in the experimental section of the specification. The averaged individual pellet hardness is preferably in the range from 10 to 100 cN, more preferred in the range from 12 to 70 cN and most preferred in the range from 15 to 40 cN. If the averaged individual pellet hardness is below the above lower limit, the target product tends to be too fragile in handling and processing and increased amounts of lower sized material may be formed before the material is employed in the desired field of application, such as, e.g., as a reinforcing filler in rubber production. However, if the averaged individual pellet hardness is above the above upper limit, the target product may be too stable when employed in the desired field of application, since it is typically desired that the target product forms smaller particles in the target systems such as a rubber composition and thus becomes more homogeneously dispersed is such systems, showing an increased reinforcing property compared to the particulate carbon material used as starting material in the method according to the invention. The pellet hardness values can be determined as described in the experimental section of the specification.

A further improvement of the target material over the starting material is that the target material enables a dust-free mixing process and a reduced mixing time when used as a filler in a target matrix material, e.g., rubber composition, while at the same time ensuring an improved dispersion within the target matrix material and an overall lower energy consumption.

Furthermore, the target particulate carbon material, when used in a rubber composition exhibits an improved in-rubber performance of the vulcanized rubber composition when used as a reinforcing filler, as can be demonstrated, e.g., by higher values of the tensile moduli M100, M200, M300 and M500, the shore A hardness and the performance index PI300.

Several other properties remain the same as in the particulate carbon starting material provided in step a. of the method according to the invention, such as the ¹⁴C content, the statistical thickness surface area (STSA), the BET surface area, the oxygen content and carbon content and pH value and the dry matter content as defined above, particularly when the particulate carbon starting material consists of the hydrothermally treated lignin. Therefore, with respect to the afore-mentioned values it is referred to the particulate carbon starting material and particularly the hydrothermally treated lignin, the values of which also apply to the agglomerated particulate carbon material of the invention.

### Use of the Agglomerated Particulate Carbon Material of the Invention in Polymeric Material and Polymeric Material Containing Such Carbon Material

The term “polymeric material” is used for any polymeric material.

The term “polymer” as defined in DIN ISO 1382:2016-07 denotes a substance composed of molecules characterized by the multiple repetition of one or more species of atoms or groups of atoms (constitutional units) linked to each other in amounts sufficient to provide a set of properties that do not vary markedly with the addition or removal of one or a few of the constitutional units. Consequently, the term “polymeric material” as used herein refers to a material comprising or consisting of polymers.

In this context the term “comprising” means that other ingredients, particularly those not being polymers may also be part of the polymeric material, while “consisting of” means that only those ingredients, which are listed in a specific context or formulation are contained. In the present invention, if not defined otherwise, the term “comprising” also encompasses the special case of “consisting of.” This is also the case for “methods” or the “method according to the invention”, which comprises steps a. to e, but not necessarily consists of those steps, since further steps, such as, e.g., recycling steps, are also encompassed by the term “comprising.”

In general, polymeric materials include materials such as thermoplastics, being any plastic polymer material that becomes pliable or moldable at a certain elevated temperature and solidifies upon cooling; or thermosetting polymers, being polymers that are obtained by irreversibly hardening (“curing”) a soft solid or viscous liquid prepolymer. Curing a thermosetting resin transforms it into a plastic, or elastomer (rubber) by crosslinking or chain extension through the formation of covalent bonds between individual chains of the polymer.

Most preferred polymeric material, wherein the agglomerated carbon material of the present invention may suitably be used, is rubber.

According to DIN ISO 1382:2016-07 the term “rubber” has three different definitions, dependent on context. It can be the finished material of a product but can also be a raw material or an intermediate material used during the manufacture of a product.

If the term “rubber” is used in view of the finished material of a product, it denotes a family of polymeric materials which are flexible and elastic. It can be substantially deformed under stress but recovers quickly to near its original shape when the stress is removed. It is usually made from a mixture of materials (solid or liquid), and in most products the base polymer is crosslinked by either chemical or physical links (“vulcanized”).

If the term “rubber” is used for raw materials, the term means natural or synthetic elastic polymers (elastomers) which forms the basis of the compound used in many rubber products.

If the term “rubber” is used for an intermediate material used during the manufacture of a product, it is used in the meaning of “compound,” which is an intimate mixture of a rubber or rubbers or other polymer-forming materials with all the ingredients necessary for the finished product. This is herein also called “vulcanizable rubber.”

### Vulcanizable Rubber (“Compounds”) and Compounding Ingredients

Such “compounds” contain besides the “rubber” so-called “compounding ingredients,” which are substance added to a rubber or rubber latex to form a mix.

After mixing, such compounds are typically vulcanized, i.e., cured to vulcanized rubber. The terms “vulcanization” and “cure” denote a process, usually involving heat, in which rubber, through a change in its chemical structure (for example, crosslinking), is converted to a condition in which the elastic properties are conferred or re-established or improved or extended over a greater range of temperatures. This is accomplished by use of a “vulcanizing agent,” which is a compounding ingredient that produces crosslinking in rubber. The vulcanizing agent is part of a “vulcanizing system,” which is defined as a combination of vulcanizing agent and, as required, accelerators, activators, retarders, etc., used to produce the desired vulcanization characteristics and vulcanizate properties.

The amounts of compounding ingredients are typically expressed in parts per hundred rubber (also: pphr or phr), which is the mass of compounding ingredient added to one hundred mass units of elastomer.

As shown in the experimental part of the specification, the thus produced vulcanizable rubber compositions differ from prior art rubber compositions making use of non-agglomerated particulate carbon material, because the thereof produced vulcanized rubber articles show an increased tensile strength and significantly better performance index.

Rubbers as raw material comprise, but are not limited to natural rubber (NR); polybutadiene rubber (BR); polyisoprene rubber (IR); styrene-butadiene rubber (SBR); acrylonitrile-butadiene rubber (NBR); ethylene-propylene rubber (EPM, EPDM); butyl rubber (IIR); halobutyl rubber (BIIR, CIIR); chloroprene rubber (CR); chlorinated polyethylene (CM); chlorosulfonated polyethylene (CSM); epichlorohydrin rubber (ECO/CO/ETER); fluoro rubber (FPM); perfluoro rubber (FFPM); tetrafluoroethylene propylene rubber (TFE/P); acrylate rubber (ACM); ethylene acrylate rubber (AEM); ethylene vinyl acetate rubber (EVM); polysulfide rubber (T); silicone rubber; norbornene rubber (PNR); polyurethane rubber; and thermoplastic elastomers (TPE).

Compounding ingredients comprise, but are not limited to accelerators, which are used in small amounts with a vulcanizing agent to increase the speed of vulcanization and/or enhance the physical properties of the vulcanizate; activators, which used in small proportions to increase the effectiveness of an accelerator; adhesion promoters, which are added to unvulcanized rubber to promote good bonding of rubber to another material; antidegradants, which are used to retard deterioration by ageing, e.g., antioxidants; anti-flex-cracking agents, which are used to retard cracking caused by cyclic deformation; coagents, which are used in low concentrations to increase the crosslinking efficiency of certain non-sulfur vulcanizing systems or to modify the properties achieved by such systems; colorants, such as pigments or dyestuff; coupling agents, which enhance reinforcement by providing a chemical bond between the filler particles and the rubber; desiccants, which are to absorb moisture present in a rubber compound or mix in order to reduce porosity in the final product; fillers, being solid compounding ingredients, in particulate form, which may be added in relatively large proportions to a rubber or rubber latex for technical or economic purposes, such as the agglomerated particulate carbon material according to the present invention, carbon black, mineral fillers, such as clays carbonates and silicates; plasticizers, which are used to enhance the flexibility of a rubber or product, especially at low temperature; prevulcanization inhibitors, which increase the time during which there is no significant crosslinking of a rubber compound at processing and vulcanizing temperatures, but have a negligible effect on the cure rate at the vulcanization temperature; processing aids, which improve the processability of a rubber compound or mix; reinforcing agents, which are used in rubber to increase resistance to mechanical force; retarders, which are used to reduce the tendency of a rubber compound to vulcanize prematurely; softeners, which are used in small proportions to reduce the viscosity of an unvulcanized rubber mix or the hardness of a vulcanizate; stiffeners, which are used to increase the viscosity of an unvulcanized rubber mix; tackifiers, which are used to increase the tack of unvulcanized rubber; UV absorbers, which, through their ability to absorb ultra-violet radiation, retard the deterioration caused by the UV component of sunlight and/or other light sources; and vulcanizing agents or curing agents, which produce crosslinking in rubber.

Amongst the fillers as compounding ingredient, it is mandatory in the present invention that the target material of the invention, i.e., the agglomerated particulate carbon material of the invention is employed in the rubber matrix. In this process, the agglomerated particulate carbon material of the invention at least partially deagglomerates.

It was surprisingly found that compared to powdered material, the agglomerated particulate carbon material according to the invention has exactly the right balance in terms of pellet hardness, as shown by the corresponding material properties of the agglomerates, enabling an improved dispersion of the agglomerated particulate carbon material in the rubber matrix, as well as their in-rubber performance data after vulcanization, exemplified, e.g., by improved stress-strain properties and a significantly higher M300 performance index PI300, whilst, concomitantly, enabling a virtually dust-free mixing with rubber matrix material and compounding ingredients prior to the vulcanization.

Thus, the agglomerated particulate carbon material according to the invention acts as a “reinforcing filler,” i.e., a filler, which is not basically involved in the vulcanization process, that increases rubber stiffness and properties such as tear strength and abrasion resistance. Reinforcing or active fillers are preferably characterized by a higher specific surface area than “inactive fillers” (also denoted “inert fillers”), which are fillers having no reinforcing effect. In contrast to inert fillers, reinforcing fillers can change the viscoelastic properties of the rubber by interacting with a rubber within a rubber composition. For example, they can influence the viscosity of the rubber and can improve the tensile-elongation behavior and the fracture behavior of the vulcanizates, for example regarding tear strength, tear propagation resistance and abrasion. Inert fillers, on the other hand, dilute the rubber matrix and lead, for example, to a reduction in fracture energy.

Preferably, the vulcanizable rubber composition, i.e., compound according to the invention is prepared by employing an amount of the agglomerated particulate carbon material according to the invention ranging from 1 to 250 phr, more preferably from 5 to 200 phr, most preferably from 10 to 150 phr, even more preferably from 15 to 120 phr.

In addition to the employment of the agglomerated particulate carbon material according to the invention, the rubber composition may contain one or more further filler(s) differing from this filler.

In the case that the agglomerated particulate carbon material according to the invention serves only as a partial substitute for common industrial carbon blacks, the rubber compositions according to the invention may also contain carbon blacks, in particular furnace carbon blacks such as those classified as general-purpose carbon blacks under ASTM code N660 or under ASTM code N550.

In addition to, or alternatively to the use of additional carbon black(s), the rubber compositions according to the invention may contain particularly inorganic fillers, for example of different particle size, particle surface area and chemical nature with different potential to influence specific properties, but in particular the processing behavior (rheology).

If further fillers are used, these are preferably mineral fillers, such as phyllosilicates like clay minerals, for example talc; carbonates such as calcium carbonate; silicates such as calcium silicate, magnesium silicate and aluminum silicate; and oxides such as magnesium oxide and silica or silicic acid.

In the context of the present invention, however, zinc oxide is not included among the inorganic fillers, since the function of zinc oxide is rather that of a vulcanization-promoting additive. Additional fillers should, however, be chosen with care, since silica, for example, tends to bind organic molecules to its surface and may thus inhibit their action.

As described above, the vulcanizable rubber composition (compound) may contain various further compounding ingredients, which may largely vary in type and amount, depending on the type of rubber used and the field of application. For the respective fields of application, the skilled one knows which types and amounts are to be selected. In the textbook “Kautschuk Technologie-Werkstoffe Verarbeitung Produkte” (3rd revised and expanded edition, 2013, pages 1196-1197), from Röthemeyer and Sommer, vulcanizable rubber compositions for all kinds of the above-mentioned rubbers are disclosed together with the specific compounding ingredients that may be used these vulcanizable rubber compositions.

### Vulcanized Rubber Composition

The vulcanizable rubber compositions produced, preferably undergo shaping processes tailored to the end articles prior to vulcanization. The rubber compositions are preferably formed by extrusion or calendaring into a suitable shape required for the vulcanization process. Vulcanization can take place in vulcanization molds via pressure and temperature, or vulcanization takes place without pressure in temperature-controlled channels in which air or liquid materials provide heat transfer.

Thus, another embodiment of the present invention is a vulcanized rubber composition obtainable by vulcanizing the vulcanizable rubber composition according to the invention.

All preferred embodiments described hereinbefore in connection with the vulcanizable rubber composition according to the invention as well as the process according to the invention, are also preferred embodiments with respect to the vulcanized rubber composition according to the invention.

Typically, vulcanization is performed under pressure and/or heat. Suitable vulcanization temperatures are preferably 100 °C to 200 °C, particularly preferably 120 °C to 180 °C, and most preferably 140 °C to 170 °C. Optionally, the vulcanization is carried out at a pressure in the range from 50 bar to 300 bar. However, it is also possible to carry out vulcanization at a pressure range of 0.1 bar to 1 bar, for example in the case of profiles. The closing pressure of the press is usually in a range of 150 bar to 500 bar, depending on the compound and product geometry.

### Use of the Agglomerated Particulate Carbon Material of the Invention

A further subject matter of the invention is the use of the agglomerated particulate carbon material of the invention, i.e., the target material of the invention, in polymeric material, preferably rubber as a polymeric material. Thus, the target material is employed in the vulcanizable rubber composition. In this process, at least part of the target material of the invention is re-dispersed, i.e., disintegrates and finely distributes throughout the bulk phase of the rubber compound.

Polymeric Material Comprising Particulate Carbon Material Formed from the Agglomerated Particulate Carbon Material

The term “particulate carbon material formed from the agglomerated particulate carbon material” means that in the course of introducing/employing the agglomerated particulate carbon material into the polymeric material, such as in the rubber material, and even at later stages, e.g., during curing the polymeric material, the agglomerated particulate carbon material is at least partially deagglomerated. Thus, the particulate carbon material formed from the agglomerated particulate carbon material is an at least partially deagglomerated carbon material formed by at least partial disintegration of the agglomerates thereby forming particulate carbon material of smaller size.

The polymeric material can be any one of the polymeric materials described above. The polymeric material can be cured or uncured. Most preferably the polymeric material is a rubber material, even more preferred a vulcanized rubber article.

Such rubber material or rubber article includes, e.g., tires, preferably pneumatic tires and solid tires, and tire components, preferably such tire components, for which the lowest possible tan δ value of the vulcanized rubber compositions used for their production is targeted, such as, for example, rubber compositions comprising natural rubber(s) and/or rubbers having a low glass transition temperature T_{g}, in particular tire components selected from the group consisting of base components, i.e. components below the tread, components below the tire tread and components below the tire tread, i.e., components below the tread, shoulder strips (wing), cap-ply belts, belts, bead cores and/or bead reinforcements; or rubber articles such as technical rubber articles, preferably drive belts, belts, molded parts such as buffers, bearings, in particular hydromounts, conveyor belts, profiles, seals, rings and/or hoses.

The term “mechanical rubber goods” (MRG) is known to the skilled person. Examples of technical rubber goods are drive belts, belts, molded parts such as buffers, bearings, particularly hydromounts, conveyor belts, profiles, seals, dampers and/or hoses.

All preferred embodiments described hereinbefore in connection with any subject matter of the invention are also preferred embodiments with respect to the afore-mentioned polymeric material.

### Rubber Articles, in Particular Technical Rubber Articles

A further embodiment of the present invention is a rubber article, in particular a technical rubber article, preferably selected from drive belts, belts, molded parts such as buffers, bearings, in particular hydromounts, conveyor belts, profiles, seals, rings and/or hoses, produced using the vulcanizable rubber composition according to the invention or the vulcanized rubber composition according to the invention.

In the following, the invention is further explained by means of examples.

### EXPERIMENTAL SECTION

### Methods

### Determination of the ¹⁴C Content

The ¹⁴C content (biobased carbon content) is determined using the radiocarbon method according to DIN EN 16640:2017-08.

### Determination of the Carbon Content

The carbon content is determined by elemental analysis according to DIN 51732:2014-7.

### Determination of the Dry Matter Content

The dry matter content of the sample was determined in accordance with DIN 51718:2002-06 as follows. For this purpose, the MA100 moisture balance from Sartorius was heated to a drying temperature of 105 °C. The dry sample, if not already in powder form, was mortared or ground to a powder. Approximately 2 g of the sample to be measured was weighed on a suitable aluminum pan in the moisture balance and then the measurement was started. As soon as the weight of the sample did not change by more than 1 mg for 30 s, this weight was considered constant and the measurement was terminated. The dry matter content then corresponded to the displayed content of the sample in wt %. At least one duplicate determination was performed for each sample. The weighted mean values were indicated.

### Determination of the BET and STSA Surface Area

The specific surface area of the material under investigation was determined by nitrogen adsorption in accordance with the ASTM D 6556 (2019 Jan. 1) standard intended for industrial carbon blacks. According to this standard, the BET surface area (Brunauer, Emmett and Teller total specific surface area) and the external surface area (STSA surface area; Statistical Thickness Surface Area) were also determined as follows.

The sample to be analyzed was dried to a dry matter content ≥97.5 wt % at 105 °C before measurement. In addition, the measuring cell was dried in a drying oven at 105 °C for several hours before weighing in the sample. The sample was then filled into the measuring cell using a funnel. If the upper measuring cell shaft became contaminated during filling, it was cleaned using a suitable brush or pipe cleaner. In the case of strongly floating (electrostatic) material, glass wool was weighed in addition to the sample. The glass wool served to retain any floating material that could contaminate the instrument during the heating process.

The sample to be analyzed was baked out at 150 °C for 2 hours, the Al₂O₃ standard at 350 °C for 1 hour. The following N₂ dosage was used for the determination depending on the pressure range:
p/p0=0-0.01: N₂ dosage: 5 ml/g.
p/p0=0.01-0.5: N₂ dosage: 4 ml/g.

For determination of BET surface area, extrapolation was performed in the range of p/p0=0.05-0.3 with at least 6 measurement points. To determine the STSA, extrapolation was performed in the range of the layer thickness of the adsorbed N2 from t=0.4-0.63 nm (corresponds to p/p0=0.2-0.5) with at least 7 measuring points.

### Determination of the Dust Explosion Class and Kₛₜ Value

The maximum explosion pressure rise over time, or the Kₛₜ value, provides information on the explosive strength of a dust and quantifies the maximum effects to be expected from a dust explosion. The dust explosion class and Kₛₜ values were determined according to the EN 14034-2 standard procedure.

### Determination of the Combustibility Index

The combustibility index was determined according to the DIN EN 17077:2018 standard procedure.

### Determination of the Individual Pellet Hardness (IPH)

The individual pellet hardness was determined according to the ASTM D5230 standard procedure.

### Determination of the Pellet Size Distribution

The pellet size distribution was determined according to the ASTM D1511 standard procedure. The median pellet size (d₅₀) was determined by linear interpolation using cumulated masses. An example calculation is found in section 2.1 below.

### Determination of the Hardness (Shore a Hardness)

The Shore A hardness of the vulcanized rubber compositions was determined using the digital Shore hardness tester from Sauter GmbH in accordance with ISO 48-4:2018-08 at 23 °C. In order to achieve the specimen thickness of at least 6 mm required by the standard, the specimen was composed of no more than 3 layers. For this purpose, three S2 bars, punched out to perform the tensile test according to ISO 37:2011, were stacked on top of each other. Five measurements were performed on each specimen stack at different points of the stack. The results obtained represent the average value of these five measurements. Between vulcanization and testing, the specimens were stored for at least 16 h at room temperature.

### Determination of Stress-Strain Properties

The determination of stress-strain properties of the vulcanized rubber samples was performed according to ISO 37:2011 using a Gibitre Instruments Tensor Check testing device with a traverse speed of 200 mm/min. Before testing, samples were stored for at least 16 h at room temperature after vulcanization. Five type 2 dumb-bell specimens were cut from each vulcanized plate with a standard thickness of 2 mm. The determination of the thickness was performed with calibrated thickness gauge (Käfer Messuhren). The thickness was calculated as average of three measurements at individual points along the bar. The reported values for tensile strength, elongation at break and tensile moduli, i.e., the 100% modulus M100 (tensile stress at 100% elongation), the 200% modulus M200 (tensile stress at 200% elongation), the 300% modulus M300 (tensile stress at 300% elongation) and the 500% modulus M500 (tensile stress at 500% elongation), are the mean of a series of five measurements.

The M300 performance index PI300 was determined as described in the examples section 3.2.

### Comparative and Working Examples

The following examples and comparative examples are intended to explain the invention but are not to be construed restrictively.

### 1. Preparation of Powder Samples F1

The lignin-based powder sample F1 was obtained by hydrothermal treatment (HTT) analogously to the process for hydrothermal treatment described in WO 2017/085278. For this purpose, a liquid containing a lignin was provided. First, water and lignin were mixed and a lignin-containing liquid with an organic dry matter content of 14 wt.-% was prepared. The lignin was then predominantly dissolved in the lignin-containing liquid by adding NaOH (10 wt.-% based on raw material). The preparation of the liquid was assisted by intensive mixing at 80 °C for 3 h. In order to adjust the pH value, the lignin-containing liquid was further diluted with water and acidified by 96% —H₂SO₄ (3 wt.-% based on raw material). The organic dry matter content of the lignin-containing solution was 5 wt.-%, after dilution and acidification. After mixing, the lignin-containing liquid is modified with formaldehyde (7 wt.-% based on raw material) at 80 °C for 1 h. The lignin-containing liquid was subjected to hydrothermal treatment. Therefore, the prepared suspension was heated at 1.5 K/min to the reaction temperature of 190 °C, which was maintained over a period of 3 h, followed by cooling, resulting in an aqueous suspension of the solid target material. The solid fraction was largely dewatered by filtration and washed with water.

In addition to the description of the HTT process in WO 2017/085278, subsequent drying was performed under nitrogen atmosphere and reduced pressure (100 mbar) using a vacuum paddle drier. The material was heated to 190 °C, kept at this temperature for one hour and cooled down again. The dried solid was deagglomerated on a counter jet mill with nitrogen to a d99 value <20 μm.

The lignin-based powder sample F1 obtained by hydrothermal treatment was characterized by the above methods and the results are indicated in Table 1.1 below.

The sample had a ¹⁴C-content in a range from 0.20 to 0.45 Bq g⁻¹ of carbon. The dust explosion class as determined according to the EN 14034-2 standard procedure was 3 and the combustibility index as determined according to the DIN EN 17077:2018 standard procedure was 5 at 100 °C. The median particle size was determined by laser diffraction according to ISO 13320:2009 as described above.

TABLE 1.1
Properties of powder sample F1 obtained
by hydrothermal treatment

| Parameter | Unit | Powder F1 |
|---|---|---|
| Kₛₜ value | bar m s⁻¹ | 319 |
| dust explosion class | — | 3 |
| combustibility index 100 °C | — | 5 |
| median particle size | μm | <20 |

### 2. Preparation and Material Characteristics of an Agglomerate Example AF1 According to the Method of the Invention

Powder sample F1 was agglomerated using different granulator settings leading to agglomerate AF1 as an example of an embodiment of the present invention.

### 2.1. Preparation of Agglomerate AF1 According to the Invention

Powder F1 was provided (“step a.”) by means of a Combi Vent® Feeder (screw feeder) equipped with a vacuum filter (10 μm, Haver Porostar®) at a feed screw speed of 53 rpm to the rollers of a WP 200 roller compactor from Alexanderwerk in order to be compacted to flakes (“step b.”). The rollers of the roller compactor had circumferential side seals and a knurled roll surface. The roller compaction was performed with the roller gap set to 3.5 mm at a compaction force of 0.1 kN/cm (corresponding to 3 bar). The speed of the roller unit was 16 rpm. The flakes produced in this step were crushed (“step c.”) by means of a six-toothed flake crusher. The thus crushed flakes were subjected to granulation (“step d.”) by means of a pre-granulator equipped with a 5 mm round wire screen operated at a speed of 123 rpm and subsequently with a fine-granulator equipped with a 2.5 mm round wire screen also operated at a speed of 123 rpm. Removing carbon material particles having a particle size ≤500 μm (“step e.”) was carried out by using an Engelsmann KT 10000 screening machine, equipped with a screen with a mesh size of 630 μm, which efficiently removes not only particles having a size ≤500 μm but also particles in the range from >500 μm to ≤630 μm. Particles having a size >5000 μm were not present and thus had not to be removed. Even particles having a size >2500 μm were not present. The undergrain, i.e., the particles removed in this step were fed back to the Combi Vent® Feeder by using a Volkmann CC250 device.

To analyze the agglomerated particulate carbon material particle size distribution (after step e. above, i.e., after sieving with the screen having a mesh size of 630 μm), a screening analysis using a Haver & Böcker sieving-analysis-machine was used. For the analysis the agglomerated particulate carbon material was screened using different screens with mesh sizes of 3.150 mm, 2.500 mm, 2.000 mm, 1.000 mm, 0.500 mm, 0.250 mm, and 0.125 mm. The analysis (settings based on ASTM D1511) was set to 3 minutes, with a vibration interval of 0 seconds and a vibration intensity of 0.5 mm height per interval.

The cumulated mass of all particles from 0.000 to 1.000 mm (i.e., 0 to 1000 μm) is 0.18 wt.-%+0.18 wt.-%+1.10 wt.-%+24.11 wt.-%=25.57 wt.-%. The cumulated mass of all particles from 0.000 to 2.000 mm (i.e., 0 to 2000 μm) is 0.18 wt.-%+0.18 wt.-%+1.10 wt.-%+24.11 wt.-%+67.83 wt.-%=93.4 wt.-%. The median pellet size (d₅₀ value; 50 wt.-% value) is in the range from 1000 to 2000 μm and determined by linear interpolation as follows:

{[(50.00 wt.-%−25.57 wt.-%)/(67.83 wt.-%)]×(2000 μm−1000 μm)}+1000 μm=1360 μm.

### 2.2. Material and Explosion Characteristics of Agglomerate AF1

The agglomerate AF1 was characterized by the above methods as indicated in Table 2.1 below.

TABLE 2.1
Properties of agglomerate sample AF1 prepared
according to the method of the invention

| | | | | Agglomerate |
|---|---|---|---|---|
| Parameter | | | Unit | AF1 |
| dust explosion class | | | — | 2 |
| combustibility index 100 °C | | | — | 4 |
| agglomerated carbon | >3.150 | mm | wt.-% | 0.00 |
| material particles with | 2.500-3.150 | mm | wt.-% | 0.09 |
| a size in the range of | 2.000-2.500 | mm | wt.-% | 6.51 |
| | 1.000-2.000 | mm | wt.-% | 67.83 |
| | 0.500-1.000 | mm | wt.-% | 24.11 |
| | 0.250-0.500 | mm | wt.-% | 1.10 |
| | 0.125-0.250 | mm | wt.-% | 0.18 |
| | 0.000-0.125 | mm | wt.-% | 0.18 |

| | | |
|---|---|---|
| pellet hardness IPH average | cN | 18.5 |
| pellet hardness IPH maximum | cN | 59.9 |
| pour density | g/L | 290 |
| carbon content | wt.-% | 64.5 |
| oxygen content | wt.-% | 29.7 |
| BET surface area | m²/g | 23.9 |
| STSA | m²/g | 21.8 |
| pH value | — | 8.5 |
| median pellet size (d₅₀) | μm | 1360 |

As the comparison of Table 1.1 and Table 2.1 shows, an improvement in reducing the explosion class and the combustibility index at 100 °C is observed. Furthermore, the agglomerate AF1 according to the invention shows the advantageous pellet properties, namely pellet size, pellet size distribution and particularly pellet hardness, which lead to a particularly good in-rubber performance, as will be further shown below.

As one can see, some particles having a particle size ≤500 μm (1.46 wt.-%) are still present. However, such small amounts are in practice hardly removable and it cannot be excluded that they are even built while carrying out the sieving analysis. Nevertheless, they do not interfere with the aims of the present invention.

### 3. Preparation and Properties of the Comparative Vulcanizate Example VF1, and the Inventive Vulcanizate Example VAF1

### 3.1. Preparation of the Comparative Vulcanizable Rubber Composition RF1 and the Inventive Vulcanizable Rubber Composition RAF1, and of the Comparative Vulcanizate Example VF1 and the Inventive Vulcanizate Example VAF1

Vulcanizable rubber compositions RF1 and RAF1 with the ingredients and amounts given in Table 3.1 and the corresponding vulcanizates VF1 and VAF1 were prepared in a two-stage process using a Haake Rheomix 3000S (Thermo Fischer) equipped with Banbury type rotors. Before compounding, the mixing chamber was heated to 40 °C. The filling level of the mixing chamber was set to 70% and the quantity of each compound ingredient was calculated accordingly and weighed before mixing using a scale (Kern & SOHN GmbH).

In the first stage, a rubber composition was provided as a masterbatch by compounding the constituents of the rubber composition, which included the rubber component, the powder sample F1 (see Table 1.1), or the agglomerate sample AF1 (see Table 2.1). After starting the rotors (50 rpm) the mixing chamber was fed with rubber and the filling unit was locked pneumatically. The rubber was mixed until a total mixing time of 1 min. The filling unit of the mixing chamber was opened, ⅓ of the filler was added, the filling unit locked, and the ingredients were mixed until a total mixing time of 2 min. The filling unit of the mixing chamber was opened, ⅙ of the filler was added, followed by ½ of the oil amount, followed by ⅙ of the filler. After locking the mixing chamber again, the ingredients were mixed until a total mixing time of 4 min. The filling unit of the mixing chamber was opened, ⅙ of the filler was added, followed by ½ of the oil amount, followed by ⅙ of the filler. After locking the mixing chamber again, the ingredients were mixed until a total mixing time of 6 min. Then, a ram sweep was performed. By adjusting the rotor speed the dumping temperature was controlled.

After a total mixing time of 8 min the compound was ejected, and the temperature of the mixture determined.

TABLE 3.1
Vulcanizable rubber compositions RF1
and RAF1 (amounts in parts by weight)

| | RF1 | RAF1 |
|---|---|---|
| Ingredients | (comparative) | (inventive) |
| Keltan ® 4465 C | 150 | 150 |
| Particulate carbon material | F1: 115 | AF1: 115 |
| Tudalen 1927 | 25 | 25 |
| PEG 4000 | 2.0 | 2.0 |
| Zinc Oxide | 5.0 | 5.0 |
| Stearic Acid | 2.0 | 2.0 |
| STRUKTOL ® SU 95 | 1.5 | 1.5 |
| Vulkacit ® Merkapto/C | 1.0 | 1.0 |
| Rhenocure ®TP/S | 2.0 | 2.0 |
| Rhenogran ® TBzTD-70 | 1.5 | 1.5 |
| Total amount | 299 | 299 |
| Dumping Temperature Tₘₐₓ (°C) | 106 | 109 |

Keltan® 4465 C is a commercially available ethylene propylene diene rubber (EPDM) rubber purchased from Arlanxeo. Tudalen® 1927 of the company Hansen & Rosenthal is a commercially available paraffinic process oil used as plasticizer (softener). PEG 4000 purchased from Avokal Heller was used as vulcanizing active agent to increase the vulcanization rate. Zinc oxide (ZnO; Weiβsiegel of the company Brüggemann) was added to the rubber compound to activate sulfur vulcanization thereby reducing the vulcanization time. Stearic acid (Palmera B 1805 of the company Avokal-Heller) was used as a dispersing agent and accelerator activator in rubber compounds. STRUKTOL® SU 95 (Schill+Seilacher GmbH) is soluble sulfur with dispersants and wetting agents used as curing agent during vulcanization. Vulkacit® Merkapto/C (2-Mercaptobenzothiazole, MBT), Rhenocure® TP/S (67% zinc dialkyl dithiophosphate bound to 33% silica) and tetrabenzylthiuram disulfide (Rhenogran® TBzTD-70) are used as accelerators of natural and synthetic rubber vulcanization and have been purchased from Rhein Chemie.

After the first stage of mixing, the mixture was cooled and homogenized using a laboratory mill. The mixture was fed into the nip gap of the mill rolls. The resulting coherent sheet was rolled and fed back into the nip gap of the mill rolls again. This procedure was repeated 5 more times. Then, the sheet was placed on a cooling table until the sheet had ambient temperature.

In the second stage, the components of the crosslinking system (vulcanization system VS) were compounded. The VS consisted of 1.0 phr 2-mercaptobenzothiazole (MBT), 2.0 phr zinc dibutyl dithiophosphate, 1.5 phr 70% TBzTD-70 and 1.5 phr Struktol® SU 95 (Table 3.1).

First, the cooled sheet was cut into stripes and the ingredients of the VS were weighed using a scale (Kern & SOHN GmbH). After starting the rotors (50 rpm) at 40 °C, the mixing chamber was fed with stripes and the filling unit was locked pneumatically. The compound was mixed until a total mixing time of 2 minutes. The filling unit of the mixing chamber was opened, the ingredients of the VS were added, the filling unit locked, and the mixture was mixed until a total mixing time of 5 minutes. By adjusting the rotor speed the dumping temperature was controlled. After a total mixing time of 5 minutes the compound was ejected, and the temperature of the mixture determined.

After the second stage of mixing, the mixture was cooled and homogenized using a laboratory mill. The mixture was fed into the nip gap of the mill rolls. The resulting coherent sheet was rolled and fed back into the nip gap of the mill rolls again. This procedure was repeated 5 further times. Then the sheet was placed on a cooling table until the sheet had ambient temperature.

The resulting vulcanizable rubber compound was vulcanized at 170 °C in a laboratory press. By successive reduction of the mill rolls nip gap the vulcanizable rubber compound was rolled out to a final thickness of 3 mm free from creases using a laboratory mill. From the rolled out vulcanizable rubber compound a square with the dimensions of 250×250 mm was cut using a scissor and transferred to a laboratory press (GIBTITRE Instruments S.R.L. Vulcanization Press with integrated mould for 2 mm standard plates). The curing time of the 2 mm standard plate was determined based on the t95 value (0.5° arc, 1.67 Hz) measured using a moving die rheometer (MDR 3000 Professional, MonTech® Rubber Testing Solutions) plus one minute per plate thickness (therefore plus two using a frame for 2 mm standard plates). After vulcanization the vulcanized plate was immediately withdrawn from the press. The plate was placed on a cooling desk and stored for at least 16 h at room temperature after vulcanization. After cooling, the protruding frame was trimmed carefully using a scissor.

### 3.2. Properties of the Comparative Vulcanizate Example VF1 and of the Inventive Vulcanizate Example VAF1

The properties of comparative vulcanizate VF1 prepared from powder samples F1 and inventive vulcanizate VAF1 prepared from agglomerate sample AF1 were characterized by the above methods as indicated in Table 3.2 below.

TABLE 3.2
Properties of vulcanizates VF2-1 and VF2-2

| | | | Vulcanizate VF1 | Vulcanizate VAF1 |
|---|---|---|---|---|
| Parameter | | Unit | (comparative) | (inventive) |
| hardness (RT Shore A) | | ° | 53 | 57 |
| modulus | M100 | MPa | 1.32 | 1.64 |
| | M200 | MPa | 1.76 | 2.24 |
| | M300 | MPa | 1.98 | 2.49 |
| | M500 | MPa | 2.42 | 3.08 |

| | | | |
|---|---|---|---|
| performance index PI300 | — | 100 | 126 |

The inventive vulcanizate VAF1, making use of the agglomerated particulate carbon material of the invention, has an increased Shore A hardness at room temperature, improved moduli (tensile stress at an elongation of 100, 200, 300 and 500%) and a significantly improved in-rubber performance in terms of the performance index PI300, if compared with comparative vulcanizate example VF1, wherein non-agglomerated particulate carbon material was employed.

The improved in-rubber performance can also be expressed by the M300 performance index PI300 of the vulcanizates, which can be calculated from the 300% modulus (M300) values as follows:

$$PI 300 ( VF 1 ) = 100 + \frac{M 300 ( VF 1 ) - M 300 ( VF 1 )}{M 300 ( VF 1 )} * 100 = 100$$

$$PI 300 ( VAF 1 ) = 100 + \frac{M 300 ( VAF 1 ) - M 300 ( VF 1 )}{M 300 ( VF 1 )} * 100 = 126$$

The performance index PI300 is shown indexed to the corresponding comparative examples VF1 as 100. The larger this index, the better the reinforcement capacity (in-rubber performance) of the filler material.

1. A method for producing an agglomerated particulate carbon material, the method comprising:
providing a particulate carbon starting material comprising hydrothermally treated lignin particles, the particulate carbon starting material having a particle size ≤500 μm;
compacting the particulate carbon starting material by applying a compaction force to form a compacted particulate carbon material;
crushing the compacted particulate carbon material to form a crushed compacted carbon material;
subjecting the crushed compacted carbon material to at least one granulator, to further reduce the size of the crushed compacted carbon material, and form a mixture of agglomerated particulate carbon material having a particle size >500 μm and ≤5000 μm, and a particulate carbon material having a particle size ≤500 μm; and
removing particulate carbon material having a particle size ≤500 μm and >5000 μm, if present, from the agglomerated particulate carbon material having a particle size in the range of >500 μm and ≤5000 μm.

2. The method of claim 1, wherein compacting the particulate carbon starting material is accomplished by applying a compaction force in the range from 0.02 to 1.00 kN/cm to form a compacted particulate carbon material having a thickness in the range from 1 to 8 mm.

3. The method of claim 1, wherein the crushed compacted particulate carbon material is subjected to either
one granulator comprising a screen, the screen having a mesh size >500 μm to ≤5000 μm and the crushed compacted material being pressed through the screen, or
two or more granulators in a row, each granulator comprising a screen, the screen of the first granulator having the largest mesh size and the screen of the last granulator having a mesh size in the range from >500 μm to ≤5000 μm, and the crushed compacted material being pressed through the screen of the first granulator, and in any subsequent granulator the carbon material which was down-sized by the preceding granulator is pressed to the screen of the respective granulator.

4. The method of claim 1, wherein forming the compacted particulate carbon material is comprises roller compaction using a roller compactor comprising compaction rollers, wherein the gap between the compaction rollers is in the range from 1 to 8 mm and the compaction force is effective in said gap.

5. The method of claim 1, wherein removing particulate carbon material having a particle size ≤500 μm comprises using a sieve having a suitable mesh size.

6. The method of claim 1, wherein the compaction force and thickness of compacted particulate carbon material is varied to obtain the agglomerated particulate carbon material having a particle size in the range of >500 μm and ≤5000 μm; and an averaged individual pellet hardness in the range from 10 to 100 cN and/or a pour density in the range from 100 to 600 g/L.

7. The method of claim 1, wherein the hydrothermally treated lignin possesses
a ¹⁴C content that is greater than 0.20 Bq/g carbon and less than 0.45 Bq/g carbon; and
a carbon content in the range from 55 wt.-% to 90 wt.-%; and
a statistical thickness surface area in the range from 2 m²/g to 180 m²/g; and
a total specific surface area according to Brunauer, Emmett and Teller (BET surface area) that deviates by a maximum of 20%, from the statistical thickness surface area.

8. The method of claim 1, wherein any of the particulate carbon material removed is, with or without milling, combined with the particulate carbon starting material.

9. An agglomerated particulate carbon material obtainable by the method of claim 1 having a particle size in the range from >500 μm and ≤5000 μm.

10. The agglomerated particulate carbon material of claim 9, wherein the agglomerated particulate carbon material possesses
an averaged individual pellet hardness in the range from 10 to 100 cN;
and/or
a dust explosion class of not more than 2; and/or
a pour density in the range of 100 to 600 g/L; and/or
a median pellet size in the range from 600 μm to 4800 μm.

11. A polymeric material comprising A use of the agglomerated particulate carbon material of claim 9.

12. A polymeric material, cured or uncured, comprising particulate carbon material formed from the agglomerated particulate carbon material of claim 9.

13. The polymeric material of claim 12, wherein the polymeric material is a rubber material comprising at least one rubber and at least one further compounding ingredient.

14. The polymeric material of claim 13, wherein the polymeric material is a vulcanized rubber material.

15. The polymeric material of claim 14, wherein the polymeric material is a rubber article selected from pneumatic tires, solid tires, tire components, and technical rubber articles.
